(19) United States
(12) Patent Application Publication
(10) Pub. No.: US 2021/0335280 A1
(43) Pub. Date: Oct. 28, 2021

(54) METHOD FOR IMPROVING OVSS VOLTAGE DROP OF OLED DISPLAY PANEL AND OLED DISPLAY PANEL

(71) Applicant: SHENZHEN CHINA STAR OPTOELECTRONICS SEMICONDUCTOR DISPLAY TECHNOLOGY CO., LTD., Shenzhen (CN)

(72) Inventor: Guohui LIU, Shenzhen (CN)

(73) Assignee: SHENZHEN CHINA STAR OPTOELECTRONICS SEMICONDUCTOR DISPLAY TECHNOLOGY CO., LTD., Shenzhen (CN)

(21) Appl. No.: 16/625,774

(22) PCT Filed: Dec. 12, 2019
(86) PCT No.: PCT/CN2019/124806

§ 371 Date: Dec. 23, 2019

(30) Foreign Application Priority Data
Nov. 29, 2019 (CN) 201911206438.4

(51) Int. Cl. G09G 3/3291; G09G 3/3233; G09G 3/3258

(52) U.S. Cl. CPC G09G 3/3291; G09G 3/3233; G09G 2300/0842; G09G 2300/0819; G09G 3/3258

(57) ABSTRACT

A method for improving low voltage power source (OVSS) voltage drop of an organic light-emitting diode (OLED) display panel is provided, including: step S1, providing the OLED display panel, wherein the OLED display panel comprises an OLED panel, a plurality of sub-pixels arranged in an array on the OLED panel, and a plurality of OVSS IN traces horizontally disposed at intervals on the OLED panel; step S2, calculating an equivalent resistance R′ between the adjacent sub-pixels; step S3, calculating a current Ids flowing through each of the sub-pixels in each row according to a value of V_{data}; step S4, calculating a value of raising voltage V_{OVSS} of each of the sub-pixels in each row; step S5, adjusting the value of V_{data} and adjusting the OLED display screen.

### FIELD OF INVENTION

The present invention relates to the field of display technologies, and in particular, to a method for improving OVSS voltage drop of an organic light-emitting diode (OLED) display panel and an OLED display panel.

### BACKGROUND OF INVENTION

Organic light-emitting diode (OLED) display devices have man advantages such as self-luminous, low driving voltage, high luminous efficiency, fast response times, high definition and contrast ratio, nearly 180° viewing angles, wide operating temperature range, flexible display, and large-area full-color display, and are recognized by the industry as the most promising display devices.

OLEDs can be divided into two categories of passive driving and active driving according to the driving mode, namely direct addressing and thin film transistor (TFT) matrix addressing. Among them, the active driving is also called an active matrix (AM) type, and each light-emitting unit in the AMOLED is independently controlled by TFT addressing. A pixel driving circuit consists of the light-emitting unit and the TFT addressing circuit needs to be driven by loading a voltage of an OLED cathode connected to low voltage power source (OVSS) through a trace.

With the development of generation and technology, large-sized and high-resolution AMOLED display devices have gradually developed, correspondingly, large-sized AMOLED display devices also require larger-sized panels and a larger number of pixels, and a length of the panel trace will be longer and the resistance of the traces will be greater. Inevitably, the OVSS voltage will cause a voltage drop (IR Drop) on the trace, a resistance value of the trace makes that the OVSS voltage obtained by each pixel driving circuit is different, so that under same data signal voltage input, different pixels have different currents and brightness outputs, and resulting in uneven display brightness of an entire panel.

As shown in FIG. 1, it is a conventional layout design of an OLED display panel (10). As shown in the figure, the OVSS (20) adopts a planar connection method and is connected to a cathode of OLED of each sub-pixel. As shown in FIG. 2, it is a schematic diagram of a pixel circuit structure of the conventional art. When a plane voltage of OVSS IN is connected to the cathode of OLED from the periphery, an equivalent resistor R′ is connected therebetween, thus, when the OLED emits light, the OVSS voltage is increased compared to the OVSS IN voltage. Due to the equivalent resistor R′ of each pixel is not same, and the OVSS is also inconsistent, so the design will cause non-uniformity in the OLED display.

### TECHNICAL PROBLEM

The OVSS voltage will cause a voltage drop (IR Drop) on the trace, a resistance value of the trace makes that the OVSS voltage obtained by each pixel driving circuit is different, so that under same data signal voltage input, different pixels have different currents and brightness outputs, and resulting in uneven display brightness of an entire panel.

### SUMMARY OF INVENTION

### Technical Solutions

To solve the above problems, the technical solution provided by the present invention is as follows.

An embodiment of the present invention provides a method for improving an OVSS voltage drop of an OLED display panel, including the following steps:

step S1, providing the OLED display panel, wherein the OLED display panel comprises an OLED panel, a plurality of sub-pixels arranged in an array on the OLED panel, and a plurality of OVSS IN traces horizontally disposed at intervals on the OLED panel, the sub-pixels in each row are electrically connected to one of the OVSS IN traces, and

each of the OVSS IN traces is configured to input an OVSS voltage to each of the sub-pixels;

step S2, calculating an equivalent resistance R′ between the adjacent sub-pixels;

step S3, calculating a current I_{ds} flowing through each of the sub-pixels in each row according to a value of V_{data};

step S4, calculating a value of raising voltage V_{OVSS} of each of the sub-pixels in each row,

wherein a total current I of the sub-pixels in each row is calculated first, and then a voltage value between the adjacent sub-pixels in each row is calculated; and

step S5, adjusting the value of V_{data} according to the calculated value of raising voltage V_{OVSS} of each of the sub-pixels in each row, and using the adjusted V_{data} to drive the OLED display panel for screen display;

wherein a circuit of each of the plurality of sub-pixels comprises a first thin film transistor (T1), a second thin film transistor (T2), a third thin film transistor (T3), a first capacitor (C1), and an organic light-emitting diode (D); and

wherein in the step S2, a calculation formula for the equivalent resistance R′ is:

R′=ρ*L/(W*H),

where ρ is conductivity, L is a length of the OVSS IN trace between the adjacent sub-pixels, W is a line width of the OVSS IN trace, and H is a thickness of the OVSS IN trace.

According to the method for improving OVSS voltage drop of the OLED display panel provided by the embodiment of the present invention, wherein in the step S3, a calculation formula for the current I_{ds} flowing through each of the sub-pixels in each row is:

I_{ds}=K(V_{data}−Vₜₕ)\hat{ }2.2,

where K is conductivity, V_{data} is a data signal voltage, and Vₜₕ is a threshold voltage.

According to the method for improving OVSS voltage drop of the OLED display panel provided by the embodiment of the present invention, wherein in the step S4, a calculation formula for the total current I of the sub-pixels in each row is:

I₁=I_{ds}P(1,1)+I_{ds}P(1,2)+I_{ds}P(1,3)+. . . +I_{ds}P(1,n),

where I1 is a total current of the sub-pixels in a first row, I_{ds} P(1,1) is a current value of a first sub-pixel in the first row, I_{ds} P(1,2) is a current value of a second sub-pixel in the first row, I_{ds} P(1,3) is a current value of a third sub-pixel in the first row, . . . , I_{ds} P(1, n) is a current value of the n-th sub-pixel in the first row, and so on, I2 is a total current of the sub-pixels in a second row, I_{ds} P(2,1) is a current value of the first sub-pixel in the second row, I_{ds} P(2,2) is a current value of a second sub-pixel in the second row, I_{ds} P(2,3) is a current value of a third sub-pixel in the second row, . . . , and I_{ds} P(2, n) is a current value of a n-th sub-pixel in the second row, and so on until a total current Im of the sub-pixels in a m-th row.

According to the method for improving OVSS voltage drop of the OLED display panel provided by the embodiment of the present invention, wherein in the step S4, a voltage-current relationship calculation formula for the adjacent sub-pixels is:

V_{OVSS}P(1,1)=I1*R′;

V_{OVSS}P(1,2)−V_{OVSS}P(1,1)=(I1−I_{ds}P(1,1))*R′;

V_{OVSS}P(1,3)−V_{OVSS}P(1,2)=(I1−I_{ds}P(1,1)−I_{ds}P(1,2))*R′;

V_{OVSS}P(1,4)−V_{OVSS}P(1,3)=(I1−I_{ds}P(1,1)−I_{ds}P(1,2)−I_{ds}P(1,3))*R′;

. . . ;

and so on, and the value of raising voltage V_{OVSS} of each of the sub-pixels in each row is calculated accordingly.

According to the method for improving OVSS voltage drop of the OLED display panel provided by the embodiment of the present invention, wherein in the circuit of each of the plurality of sub-pixels, a gate of the first thin film transistor (T1) is connected to a first control signal (WR), a source is connected to the data signal (Vdata), and a drain is electrically connected to a first node (g); a gate of the second thin film transistor (T2) is electrically connected to the first node (g), a source is electrically connected to a power supply voltage (OVDD), and a drain is electrically connected to a second node (s), a gate of the third thin film transistor (T3) is electrically connected to a second control signal (RD), a source is electrically connected to the second node (s), and a drain is electrically connected to a first reference voltage (Verf); an end of the first capacitor (C1) is electrically connected to the first node (g), and the other end is electrically connected to the second node (s); and an anode of the organic light-emitting diode (D) is electrically connected to the second node (s), and a cathode is electrically connected to a corresponding OVSS trace.

An embodiment of the present invention also provides a method for improving low voltage power source (OVSS) voltage drop of an organic light-emitting diode (OLED) display panel, comprising following steps:

step S1, providing the OLED display panel, wherein the OLED display panel comprises an OLED panel, a plurality of sub-pixels arranged in an array on the OLED panel, and a plurality of OVSS IN traces horizontally disposed at intervals on the OLED panel, the sub-pixels in each row are electrically connected to one of the OVSS IN traces, and

each of the OVSS IN traces is configured to input an OVSS voltage to each of the sub-pixels;

step S2, calculating an equivalent resistance R′ between the adjacent sub-pixels;

step S3, calculating a current I_{ds} flowing through each of the sub-pixels in each row according to a value of Vdata;

step S4, calculating a value of raising voltage V_{OVSS} of each of the sub-pixels in each row,

wherein a total current I of the sub-pixels in each row is calculated first, and then a voltage value between the adjacent sub-pixels in each row is calculated; and

step S5, adjusting the value of Vdata according to the calculated value of raising voltage V_{OVSS} of each of the sub-pixels in each row, and using the adjusted Vdata to drive the OLED display panel for screen display.

According to the method for improving OVSS voltage drop of the OLED display panel provided by the embodiment of the present invention, wherein in the step S2, a calculation formula for the equivalent resistance R′ is:

R′=ρ*L/(W*H);

where ρ is conductivity, L is a length of the OVSS IN trace between the adjacent sub-pixels, W is a line width of the OVSS IN trace, and H is a thickness of the OVSS IN trace.

According to the method for improving OVSS voltage drop of the OLED display panel provided by the embodiment of the present invention, wherein in the step S3, a calculation formula for the current I_{ds} flowing through each of the sub-pixels in each row is:

I_{ds}=K(Vdata−Vₜₕ)\hat{ }2.2,

where K is conductivity, Vdata is a data signal voltage, and Vₜₕ is a threshold voltage.

According to the method for improving OVSS voltage drop of the OLED display panel provided by the embodiment of the present invention, wherein in the step S4, a calculation formula for the total current I of the sub-pixels in each row is:

Iᵢ=I_{ds}P(1,1)+I_{ds}P(1,2)+I_{ds}P(1,3)+. . . +I_{ds}P(1,n),

where I1 is a total current of the sub-pixels in a first row, I_{ds} P(1,1) is a current value of a first sub-pixel in the first row, I_{ds} P(1,2) is a current value of a second sub-pixel in the first row, I_{ds} P(1,3) is a current value of a third sub-pixel in the first row, . . . , I_{ds} P(1, n) is a current value of the n-th sub-pixel in the first row, and so on, I2 is a total current of the sub-pixels in a second row, I_{ds} P(2,1) is a current value of the first sub-pixel in the second row, I_{ds} P(2,2) is a current value of a second sub-pixel in the second row, I_{ds} P(2,3) is a current value of a third sub-pixel in the second row, . . . , and I_{ds} P(2, n) is a current value of a n-th sub-pixel in the second row, and so on until a total current Im of the sub-pixels in a m-th row.

According to the method for improving OVSS voltage drop of the OLED display panel provided by the embodiment of the present invention, wherein in the step S4, a voltage-current relationship calculation formula for the adjacent sub-pixels is:

V_{OVSS}P(1,1)=I1*R′;

V_{OVSS}P(1,2)−V_{OVSS}P(1,1)=(I1−I_{ds}P(1,1,))*R′;

V_{OVSS}P(1,3)−V_{OVSS}P(1,2)=(I1−I_{ds}P(1,1)−I_{ds}P(1,2))*R′;

V_{OVSS}P(1,4)−V_{OVSS}P(1,3)=(I1−I_{ds}P(1,1)−I_{ds}P(1,2)−I_{ds}P(1,3))*R′;

. . . ;

and so on, and the value of raising voltage V_{OVSS} of each of the sub-pixels in each row is calculated accordingly.

According to the method for improving OVSS voltage drop of the OLED display panel provided by the embodiment of the present invention, wherein a circuit of each of the plurality of sub-pixels comprises a first thin film transistor (T1), a second thin film transistor (T2), a third thin film transistor (T3), a first capacitor (C1), and an organic light-emitting diode (D).

According to the method for improving OVSS voltage drop of the OLED display panel provided by the embodiment of the present invention, wherein in the circuit of each of the plurality of sub-pixels, a gate of the first thin film transistor (T1) is connected to a first control signal (WR), a source is connected to the data signal (Vdata), and a drain is electrically connected to a first node (g); a gate of the second thin film transistor (T2) is electrically connected to the first node (g), a source is electrically connected to a power supply voltage (OVDD), and a drain is electrically connected to a second node (s), a gate of the third thin film transistor (T3) is electrically connected to a second control signal (RD), a source is electrically connected to the second node (s), and a drain is electrically connected to a first reference voltage (Verf); an end of the first capacitor (C1) is electrically connected to the first node (g), and the other end is electrically connected to the second node (s); and an anode of the organic light-emitting diode (D) is electrically connected to the second node (s), and a cathode is electrically connected to a corresponding OVSS trace.

An embodiment of the present invention further provides an organic light-emitting diode (OLED) display panel, the OLED display panel comprising an OLED panel, a plurality of sub-pixels arranged in an array on the OLED panel, and a plurality of low voltage power source (OVSS) IN traces horizontally disposed at intervals on the OLED panel, wherein the sub-pixels in each row are electrically connected to one of the OVSS IN traces, and

the OVSS IN traces are used to input an OVSS voltage to each of the sub-pixels; and

wherein when a plane voltage of each of the OVSS IN traces is connected to a cathode of the OLED panel, an R′ resistor is equivalently connected between the OVSS IN trace and the corresponding sub-pixel; when the OLED panel emits light, the OVSS voltage inputted to the sub-pixel is increased compared to a voltage on the OVSS IN trace.

According to the OLED display panel provided in the embodiment of the present invention, wherein the OLED display panel uses a method for improving OVSS voltage drop of an OLED display panel, comprising following steps:

step S1, providing the OLED display panel, wherein the display panel comprises an OLED panel, a plurality of sub-pixels arranged in an array on the OLED panel, and a plurality of OVSS IN traces horizontally disposed at intervals on the OLED panel, the sub-pixels in each row are electrically connected to one of the OVSS IN traces, and

each of the OVSS IN traces is configured to input an OVSS voltage to each of the sub-pixels;

step S2, calculating an equivalent resistance R′ between the adjacent sub-pixels;

step S3, calculating a current I_{ds} flowing through each of the sub-pixels in each row according to a value of Vdata;

step S4, calculating a value of raising voltage V_{OVSS} of each of the sub-pixels in each row,

wherein a total current I of the sub-pixels in each row is calculated first, and then a voltage value between the adjacent sub-pixels in each row is calculated; and

step S5, adjusting the value of Vdata according to the calculated value of raising voltage V_{OVSS} of each of the sub-pixels in each row, and using the adjusted Vdata to drive the OLED display panel for screen display.

According to the OLED display panel provided in the embodiment of the present invention, wherein a circuit of each of the plurality of sub-pixels comprises a first thin film transistor (T1), a second thin film transistor (T2), a third thin film transistor (T3), a first capacitor (C1), and an organic light-emitting diode (D); and

a gate of the first thin film transistor (T1) is connected to a first control signal (WR), a source is connected to the data signal (Vdata), and a drain is electrically connected to a first node (g); a gate of the second thin film transistor (T2) is electrically connected to the first node (g), a source is electrically connected to a power supply voltage (OVDD), and a drain is electrically connected to a second node (s); a gate of the third thin film transistor (T3) is electrically connected to a second control signal (RD), a source is electrically connected to the second node (s), and a drain is electrically connected to a first reference voltage (Verf); an end of the first capacitor (C1) is electrically connected to the first node (g), and the other end is electrically connected to the second node (s); and an anode of the organic light-emitting diode (D) is electrically connected to the second node (s), and a cathode is electrically connected to a corresponding OVSS trace.

### Beneficial Effect

The present invention provides a method for improving OVSS voltage drop of an OLED display panel, which adopts a new OVSS panel wiring method, calculates the voltage at which the OVSS point is raised, and compensates by V_{data}. The influence of the OVSS voltage drop on the display is avoided, and the display uniformity of the OLED display panel is improved. The present invention also provides an OLED display panel, and the display panel uses the method for improving OVSS voltage drop of the OLED display panel, which greatly enhances the display uniformity of the OLED display panel.

### BRIEF DESCRIPTION OF FIGURES

The following detailed description of specific embodiments of the present application will make the technical solutions and other beneficial effects of the present application obvious in conjunction with the accompanying drawings.

FIG. 1 is a schematic diagram of a layout design of a conventional organic light-emitting diode (OLED) display panel.

FIG. 2 is a schematic structure diagram of a pixel circuit of an OLED display panel.

FIG. 3 is a schematic diagram of a layout design of an OLED display panel according to an embodiment of the present invention.

FIG. 4 is a schematic diagram of an equivalent resistance of a plane low voltage power source (OVSS) of the OLED display panel according to an embodiment of the present invention.

FIG. 5 is a schematic diagram of equivalent resistance between adjacent sub-pixels.

FIG. 6 is a schematic flowchart showing a method for improving an OVSS voltage drop of an OLED display panel according to an embodiment of the present invention.

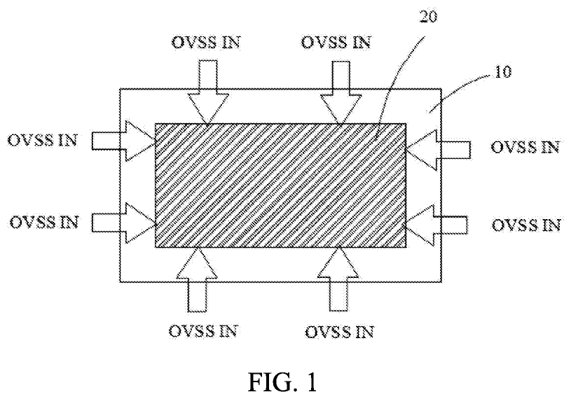

### DETAILED DESCRIPTION OF EMBODIMENTS

The technical solutions in the embodiments of the present application will be clearly and completely described below with reference to the accompanying drawings in the embodiments of the present application. Obviously, the following drawings merely relate to some embodiments of the present disclosure, and based on these drawings, a person skilled in the art may obtain the other drawings without any creative effort.

In the description of the present invention, it is to be understood that the terms such as “center”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise”, etc., the orientation or positional relationship of the indications is based on the orientation or positional relationship shown in the drawings, and is merely for the convenience of the description of the invention and the simplified description, rather than indicating or implying that the device or component referred to has a specific orientation, in a specific orientation. The construction and operation are therefore not to be construed as limiting the invention.

In addition, unless otherwise defined, any technical or scientific term used herein shall have the common meaning understood by a person of ordinary skills. Such words as “first” and “second” used in the specification and claims are merely used to differentiate different components rather than to represent any order, number or importance. In the description of the present invention, the meaning of “plurality” is two or more unless specifically defined otherwise.

In the description of this application, it should be noted that the terms “installation”, “connected”, and “coupled” should be understood in a broad sense, unless explicitly stated and limited otherwise. For example, they may be fixed connections, removable connected or integrally connected; it can be mechanical, electrical, or can communicate with each other; it can be directly connected, or it can be indirectly connected through an intermediate medium, it can be an internal communication of two elements or an interaction relationship of two elements. For those of ordinary skill in the art, the specific meanings of the above terms in this application can be understood according to specific situations.

In the present invention, the first feature “on” or “under” the second feature can include direct contact of the first and second features, and can also be included that the first and second features are not in direct contact but are contacted by additional features between them, unless otherwise specifically defined and defined. Moreover, the first feature is “above”, “on”, and “on the top of” of the second feature, including the first feature directly above and diagonally above the second feature, or simply means that the first feature is horizontally higher than the second feature. The first feature is “under”, “below”, and “beneath” the second feature, including the first feature directly below and diagonally below the second feature, or merely the first feature is horizontally less than the second feature.

The following disclosure provides many different implementations or examples for implementing different structures of the present application. To simplify the disclosure of this application, the components and settings of specific examples are described below. Of course, they are merely examples and are not intended to limit the application. Furthermore, the present application may repeat reference numbers and/or reference letters in different examples, and such repetition is for the sake of simplicity and clarity, and does not itself indicate a relationship between the various embodiments and/or settings discussed. In addition, examples of various specific processes and materials are provided in this application, but those of ordinary skill in the art may be aware of the application of other processes and/or the use of other materials.

In order to further explain the technical means adopted by the present invention and its effects, the following describes in detail with reference to the preferred embodiments of the present invention and the accompanying drawings.

As shown in FIG. 6, it is a schematic flowchart showing a method for improving OVSS voltage drop of an organic light-emitting diode (OLED) display panel according to an embodiment of the present invention, including the following steps.

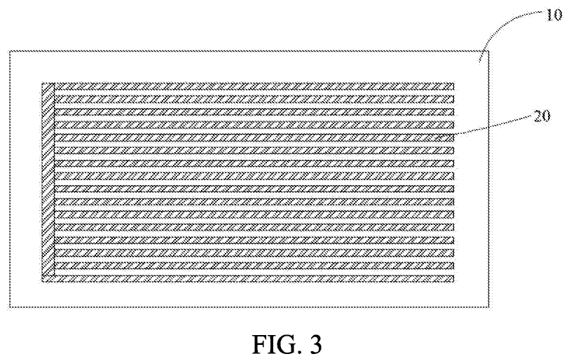

A step S1, please refer to FIG. 3, providing an OLED display panel, wherein the OLED display panel includes an OLED panel 10, a plurality of sub-pixels arranged in an array on the OLED panel 10, and a plurality of low voltage power source (OVSS) IN traces 20 horizontally disposed at intervals on the OLED panel 10, the sub-pixels in each row are electrically connected to one of the OVSS IN traces 20.

Each of the OVSS IN traces 20 is configured to input an OVSS voltage to each of the sub-pixels. The OVSS IN traces 20 are input from a left side of the OLED panel 10, and each of the OVSS IN traces 20 is connected to the sub-pixels in each row.

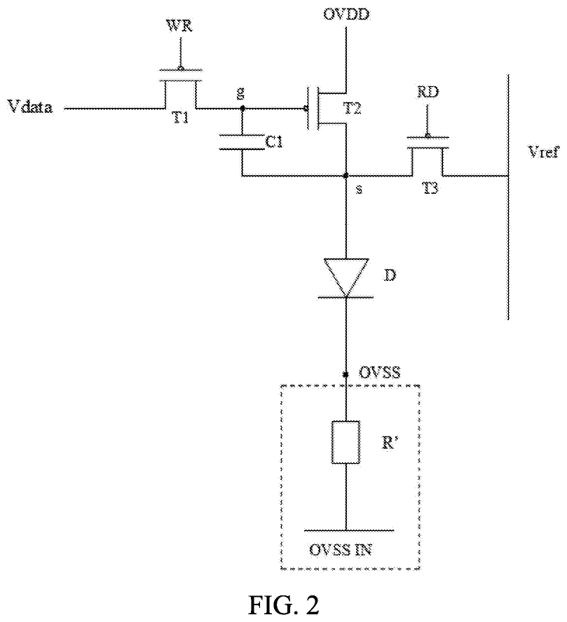

Specifically, please refer to FIG. 2, which is a schematic diagram of a pixel circuit of the sub-pixel. The pixel circuit of each of the plurality of sub-pixels includes a first thin film transistor (T1), a second thin film transistor (T2), a third thin film transistor (T3), a first capacitor (C1), and an organic light-emitting diode (D). A gate of the first thin film transistor (T1) is connected to a first control signal (WR), a source thereof is connected to a data signal (V_{data}), and a drain thereof is electrically connected to a first node (g). A gate of the second thin film transistor (T2) is electrically connected to the first node (g), a source thereof is electrically connected to a power supply voltage (OVDD), and a drain thereof is electrically connected to a second node (s). A gate of the third thin film transistor (T3) is electrically connected to a second control signal (RD), a source thereof is electrically connected to the second node (s), and a drain thereof is electrically connected to a first reference voltage (Verf). An end of the first capacitor (C1) is electrically connected to the first node (g), and the other end is electrically connected to the second node (s). An anode of the organic light-emitting diode (D) is electrically connected to the second node (s), and the cathode is electrically connected to a corresponding OVSS trace.

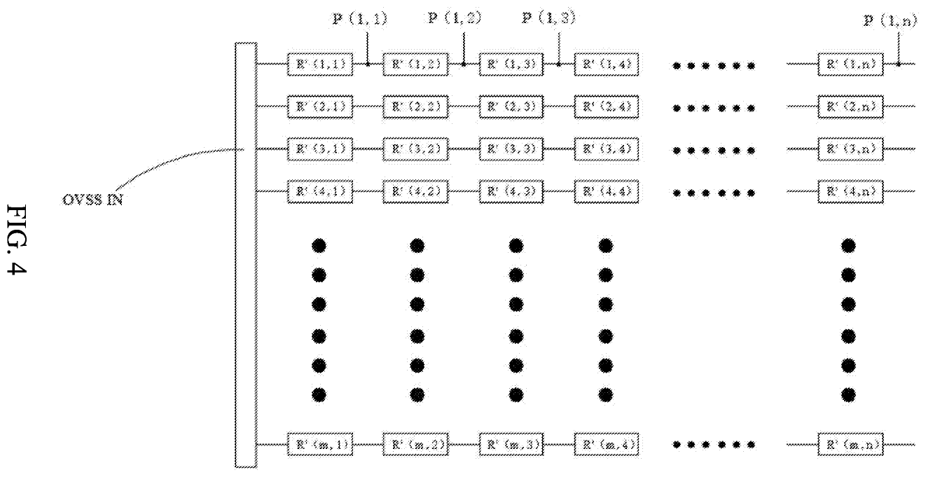

As shown in FIG. 2, according to a circuit trace layout design of the OLED panel, when the OVSS IN trace is connected to the cathode of the OLED in the circuit of the sub-pixel, it is equivalent to an equivalent resistance R′ is connected between the OVSS IN trace and the circuit of the sub-pixel. Therefore, when the OLED emits light, the OVSS voltage at the cathode of the OLED will be higher than the voltage at the OVSS IN trace. Please refer to FIG. 4, which is a schematic diagram of a planar equivalent resistance R′ of an OVSS IN trace layout design for the OLED panel described in this embodiment. The equivalent resistance R′ between adjacent sub-pixels of the sub-pixels in each row can be calculated by sizes of the OVSS IN trace layout design.

A step S2, calculating an equivalent resistance R′ between the adjacent sub-pixels.

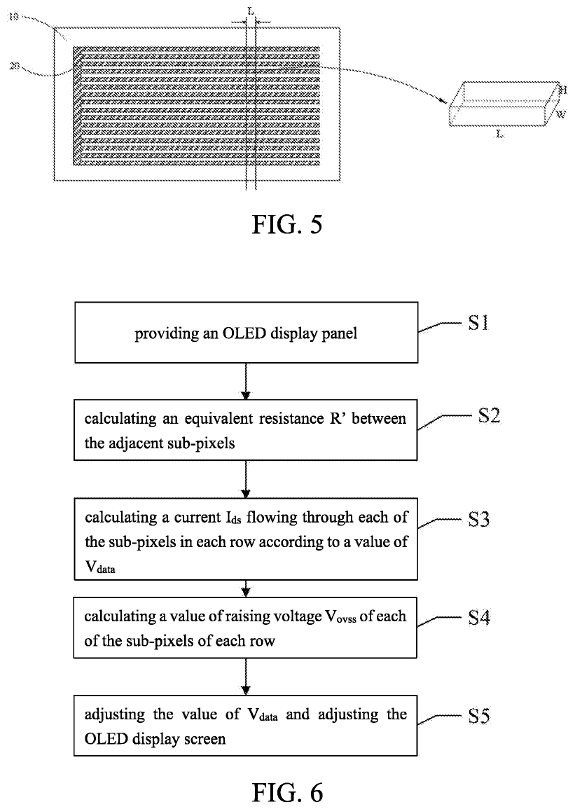

Specifically, referring to FIG. 5, in the step S2, a calculation formula for the equivalent resistance R′ is:

R′=ρ*L/(W*H),

where ρ is conductivity, L is a length of the OVSS IN trace between the adjacent sub-pixels, W is a line width of the OVSS IN trace, and H is a thickness of the OVSS IN trace.

A step S3, calculating a current Ids flowing through each of the sub-pixels in each row according to a value of V_{data}.

According to the circuit characteristics of the thin film transistor, in the step S3, a magnitude of the current I_{ds} flowing through each of the sub-pixels in each row can be calculated by a calculation, and the calculation formula for the current I_{ds} is:

I_{ds}=K(V_{data}−Vₜₕ)\hat{ }2.2,

where K is conductivity, V_{data} is a data signal voltage, and Vₜₕ is a threshold voltage.

Therefore, the corresponding current I_{ds} P(m, n) can be calculated from V_{data} in the pixel circuit, where P(m, n) represents the m-th row and the n-th sub-pixel.

A step S4, calculating a value of raising voltage V_{OVSS} of each of the sub-pixels in each row,

wherein a total current I of the sub-pixels in each row is calculated first, and then a voltage value between the adjacent sub-pixels in each row is calculated.

Specifically, referring to FIG. 4, in the step S4, a calculation formula for the total current I of the sub-pixels in each row is:

I₁=I_{ds}P(1,1)+I_{ds}P(1,2)+I_{ds}P(1,3)+. . . +I_{ds}P(1,n),

where I1 is a total current of the sub-pixels in a first row, I_{ds} P(1,1) is a current value of a first sub-pixel in the first row, I_{ds} P(1,2) is a current value of a second sub-pixel in the first row, I_{ds} P(1,3) is a current value of a third sub-pixel in the first row, . . . , I_{ds} P(1, n) is a current value of the n-th sub-pixel in the first row, and so on, I2 is a total current of the sub-pixels in a second row, I_{ds} P(2,1) is a current value of the first sub-pixel in the second row, I_{ds} P(2,2) is a current value of a second sub-pixel in the second row, I_{ds} P(2,3) is a current value of a third sub-pixel in the second row, . . . , and I_{ds} P(2, n) is a current value of a n-th sub-pixel in the second row, and so on until a total current Iₘ of the sub-pixels in a m-th row.

In the step S4, a formula for calculating the voltage-current relationship between adjacent sub-pixels is:

V_{OVSS}P(1,1)=I1*R′;

V_{OVSS}P(1,2)−V_{OVSS}P(1,1)=(I1−I_{ds}P(1,1,))*R′;

V_{OVSS}P(1,3)−V_{OVSS}P(1,2)=(I1−I_{ds}P(1,1)−I_{ds}P(1,2))*R′;

V_{OVSS}P(1,4)−V_{OVSS}P(1,3)=(I1−I_{ds}P(1,1)−I_{ds}P(1,2)−I_{ds}P(1,3))*R′;

. . . ;

and so on, and the value of raising voltage V_{OVSS} of each of the sub-pixels in each row is calculated accordingly.

A step S5, adjusting the value of V_{data} according to the calculated value of raising voltage V_{OVSS} of each of the sub-pixels in each row, and using the adjusted V_{data} to drive the OLED display panel for screen display.

Specifically, the current I_{ds} flowing through the OLED: I_{ds}=K (V_{data}−Vₜₕ)\hat{ }2.2, and the relationship between V_{OVSS} and I_{ds}: V_{OVSS}=I_{ds}*R′, the value of raising voltage V_{OVSS} of each of the sub-pixels in each row is obtained, and a voltage adjustment value of V_{data} that needs to be adjusted is calculated, and the adjusted V_{data} is used to drive the OLED display panel for screen display. In this way, the display uniformity of the OLED display panel is improved.

An embodiment of the present invention also provides an OLED display panel. The OLED display panel includes an OLED panel, a plurality of sub-pixels arranged in an array on the OLED panel, and a plurality of OVSS IN traces horizontally disposed at intervals on the OLED panel, the sub-pixels in each row are electrically connected to one of the OVSS IN traces.

Each of the OVSS IN traces is configured to input an OVSS voltage to each of the sub-pixels. When a plane voltage of the OVSS IN trace is connected to a cathode of the OLED panel, an R′ resistor is equivalently connected between the OVSS IN trace and the corresponding sub-pixel. When the OLED panel emits light, the OVSS voltage inputted to the sub-pixel is increased compared to a voltage on the OVSS IN trace.

The circuit of the sub-pixel includes a first thin film transistor (T1), a second thin film transistor (T2), a third thin film transistor (T3), a first capacitor (C1), and an organic light-emitting diode (D).

A gate of the first thin film transistor (T1) is connected to a first control signal (WR), a source thereof is connected to a data signal (V_{data}), and a drain thereof is electrically connected to a first node (g). A gate of the second thin film transistor (T2) is electrically connected to the first node (g), a source thereof is electrically connected to a power supply voltage (OVDD), and a drain thereof is electrically connected to a second node (s). A gate of the third thin film transistor (T3) is electrically connected to a second control signal (RD), a source thereof is electrically connected to the second node (s), and a drain thereof is electrically connected to a first reference voltage (Verf). An end of the first capacitor (C1) is electrically connected to the first node (g), and the other end is electrically connected to the second node (s). An anode of the organic light-emitting diode (D) is electrically connected to the second node (s), and the cathode is electrically connected to a corresponding OVSS trace.

The OLED display panel provided in the present embodiment uses the method for improving the OVSS voltage drop of the OLED display panel provided in the foregoing embodiment.

The present invention provides a method for improving OVSS voltage drop of an OLED display panel, which adopts a new OVSS panel wiring method, calculates the voltage at which the OVSS point is raised, and compensates by V_{data}. The influence of the OVSS voltage drop on the display is avoided, and the display uniformity of the OLED display panel is improved. The present invention also provides an OLED display panel, and the display panel uses the method for improving OVSS voltage drop of the OLED display panel, which greatly enhances the display uniformity of the OLED display panel.

The method for improving the OVSS voltage drop of the OLED display panel and the OLED display panel using same provided in the embodiments of the present application have been described in detail above. Embodiments of the present invention have been described, but not intended to impose any unduly constraint to the appended claims. For a person skilled in the art, any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A method for improving low voltage power source (OVSS) voltage drop of an organic light-emitting diode (OLED) display panel, comprising following steps:
step S1, providing the OLED display panel, wherein the OLED display panel comprises an OLED panel, a plurality of sub-pixels arranged in an array on the OLED panel, and a plurality of OVSS IN traces horizontally disposed at intervals on the OLED panel, the sub-pixels in each row are electrically connected to one of the OVSS IN traces, and
each of the OVSS IN traces is configured to input an OVSS voltage to each of the sub-pixels;
step S2, calculating an equivalent resistance R′ between the adjacent sub-pixels;
step S3, calculating a current I_{ds} flowing through each of the sub-pixels in each row according to a value of V_{data};
step S4, calculating a value of raising voltage V_{OVSS} of each of the sub-pixels in each row,
wherein a total current I of the sub-pixels in each row is calculated first, and then a voltage value between the adjacent sub-pixels in each row is calculated; and
step S5, adjusting the value of V_{data} according to the calculated value of raising voltage V_{OVSS} of each of the sub-pixels in each row, and using the adjusted V_{data} to drive the OLED display panel for screen display;
wherein a circuit of each of the plurality of sub-pixels comprises a first thin film transistor (T1), a second thin film transistor (T2), a third thin film transistor (T3), a first capacitor (C1), and an organic light-emitting diode (D); and
wherein in the step S2, a calculation formula for the equivalent resistance R′ is:
R′=ρ*L/(W*H),
where ρ is conductivity, L is a length of the OVSS IN trace between the adjacent sub-pixels, W is a line width of the OVSS IN trace, and H is a thickness of the OVSS IN trace.

2. The method for improving OVSS voltage drop of the OLED display panel of claim 1, wherein in the step S3, a calculation formula for the current I_{ds} flowing through each of the sub-pixels in each row is:
I_{ds}=K(V_{data}−Vₜₕ)\hat{ }2.2,
where K is conductivity, V_{data} is a data signal voltage, and Vₜₕ is a threshold voltage.

3. The method for improving OVSS voltage drop of the OLED display panel of claim 1, wherein in the step S4, a calculation formula for the total current I of the sub-pixels in each row is:
I₁=I_{ds}P(1,1)+I_{ds}P(1,2)+I_{ds}P(1,3)+. . . +I_{ds}P(1,n),
where I₁ is a total current of the sub-pixels in a first row, I_{ds} P(1,1) is a current value of a first sub-pixel in the first row, I_{ds} P(1,2) is a current value of a second sub-pixel in the first row, I_{ds} P(1,3) is a current value of a third sub-pixel in the first row, . . . , I_{ds} P(1, n) is a current value of the n-th sub-pixel in the first row, and so on, I₂ is a total current of the sub-pixels in a second row, I_{ds} P(2,1) is a current value of the first sub-pixel in the second row, I_{ds} P(2,2) is a current value of a second sub-pixel in the second row, I_{ds} P(2,3) is a current value of a third sub-pixel in the second row, . . . , and I_{ds} P(2, n) is a current value of a n-th sub-pixel in the second row, and so on until a total current Iₘ of the sub-pixels in a m-th row.

4. The method for improving OVSS voltage drop of the OLED display panel of claim 3, wherein in the step S4, a voltage-current relationship calculation formula for the adjacent sub-pixels is:
V_{OVSS}P(1,1)=I1*R′;
V_{OVSS}P(1,2)−V_{OVSS}P(1,1)=(I1−I_{ds}P(1,1,))*R′;
V_{OVSS}P(1,3)−V_{OVSS}P(1,2)=(I1−I_{ds}P(1,1)−I_{ds}P(1,2))*R′;
V_{OVSS}P(1,4)−V_{OVSS}P(1,3)=(I1−I_{ds}P(1,1)−I_{ds}P(1,2)−I_{ds}P(1,3))*R′;
. . . ;
and so on, and the value of raising voltage V_{OVSS} of each of the sub-pixels in each row is calculated accordingly.

5. The method for improving OVSS voltage drop of the OLED display panel of claim 1, wherein in the circuit of each of the plurality of sub-pixels, a gate of the first thin film transistor (T1) is connected to a first control signal (WR), a source is connected to the data signal (Vdata), and a drain is electrically connected to a first node (g); a gate of the second thin film transistor (T2) is electrically connected to the first node (g), a source is electrically connected to a power supply voltage (OVDD), and a drain is electrically connected to a second node (s); a gate of the third thin film transistor (T3) is electrically connected to a second control signal (RD), a source is electrically connected to the second node (s), and a drain is electrically connected to a first reference voltage (Verf); an end of the first capacitor (C1) is electrically connected to the first node (g), and the other end is electrically connected to the second node (s); and an anode of the organic light-emitting diode (D) is electrically connected to the second node (s), and a cathode is electrically connected to a corresponding OVSS trace.

6. A method for improving low voltage power source (OVSS) voltage drop of an organic light-emitting diode (OLED) display panel, comprising following steps:
step S1, providing the OLED display panel, wherein the OLED display panel comprises an OLED panel, a plurality of sub-pixels arranged in an array on the OLED panel, and a plurality of OVSS IN traces horizontally disposed at intervals on the OLED panel, the sub-pixels in each row are electrically connected to one of the OVSS IN traces, and
each of the OVSS IN traces is configured to input an OVSS voltage to each of the sub-pixels;
step S2, calculating an equivalent resistance R′ between the adjacent sub-pixels;
step S3, calculating a current I_{ds} flowing through each of the sub-pixels in each row according to a value of V_{data};
step S4, calculating a value of raising voltage V_{OVSS} of each of the sub-pixels in each row,
wherein a total current I of the sub-pixels in each row is calculated first, and then a voltage value between the adjacent sub-pixels in each row is calculated; and
step S5, adjusting the value of V_{data} according to the calculated value of raising voltage V_{OVSS} of each of the sub-pixels in each row, and using the adjusted V_{data} to drive the OLED display panel for screen display.

7. The method for improving OVSS voltage drop of the OLED display panel of claim 6, wherein in the step S2, a calculation formula for the equivalent resistance R′ is:
R′=ρ*L/(W*H);
where ρ is conductivity, L is a length of the OVSS IN trace between the adjacent sub-pixels, W is a line width of the OVSS IN trace, and H is a thickness of the OVSS IN trace.

8. The method for improving OVSS voltage drop of the OLED display panel of claim 6, wherein in the step S3, a calculation formula for the current I_{ds} flowing through each of the sub-pixels in each row is:
I_{ds}=K(V_{data}−Vₜₕ)\hat{ }2.2,
where K is conductivity, V_{data} is a data signal voltage, and Vₜₕ is a threshold voltage.

9. The method for improving OVSS voltage drop of the OLED display panel of claim 6, wherein in the step S4, a calculation formula for the total current I of the sub-pixels in each row is:
I1=I_{ds}P(1,1)+I_{ds}P(1,2)+I_{ds}P(1,3)+. . . +I_{ds}P(1,n),
where I₁ is a total current of the sub-pixels in a first row, I_{ds} P(1,1) is a current value of a first sub-pixel in the first row, I_{ds} P(1,2) is a current value of a second sub-pixel in the first row, I_{ds} P(1,3) is a current value of a third sub-pixel in the first row, . . . , I_{ds} P(1, n) is a current value of the n-th sub-pixel in the first row, and so on, I₂ is a total current of the sub-pixels in a second row, I_{ds} P(2,1) is a current value of the first sub-pixel in the second row, I_{ds} P(2,2) is a current value of a second sub-pixel in the second row, I_{ds} P(2,3) is a current value of a third sub-pixel in the second row, . . . , and I_{ds} P(2, n) is a current value of a n-th sub-pixel in the second row, and so on until a total current Iₘ of the sub-pixels in a m-th row.

10. The method for improving OVSS voltage drop of the OLED display panel of claim 9, wherein in the step S4, a voltage-current relationship calculation formula for the adjacent sub-pixels is:
V_{OVSS}P(1,1)=I1*R′;
V_{OVSS}P(1,2)−V_{OVSS}P(1,1)=(I1−I_{ds}P(1,1))*R′;
V_{OVSS}P(1,3)−V_{OVSS}P(1,2)=(I1−I_{ds}P(1,1)−I_{ds}P(1,2))*R′;
V_{OVSS}P(1,4)−V_{OVSS}P(1,3)=(I1−I_{ds}P(1,1)−I_{ds}P(1,2)−I_{ds}P(1,3))*R′;
. . . ;
and so on, and the value of raising voltage V_{OVSS} of each of the sub-pixels in each row is calculated accordingly.

11. The method for improving OVSS voltage drop of the OLED display panel of claim 6, wherein a circuit of each of the plurality of sub-pixels comprises a first thin film transistor (T1), a second thin film transistor (T2), a third thin film transistor (T3), a first capacitor (C1), and an organic light-emitting diode (D).

12. The method for improving OVSS voltage drop of the OLED display panel of claim 11, wherein in the circuit of each of the plurality of sub-pixels, a gate of the first thin film transistor (T1) is connected to a first control signal (WR), a source is connected to the data signal (V_{data}), and a drain is electrically connected to a first node (g); a gate of the second thin film transistor (T2) is electrically connected to the first node (g), a source is electrically connected to a power supply voltage (OVDD), and a drain is electrically connected to a second node (s); a gate of the third thin film transistor (T3) is electrically connected to a second control signal (RD), a source is electrically connected to the second node (s), and a drain is electrically connected to a first reference voltage (Verf); an end of the first capacitor (C1) is electrically connected to the first node (g), and the other end is electrically connected to the second node (s); and an anode of the organic light-emitting diode (D) is electrically connected to the second node (s), and a cathode is electrically connected to a corresponding OVSS trace.

13. An organic light-emitting diode (OLED) display panel, the OLED display panel comprising an OLED panel, a plurality of sub-pixels arranged in an array on the OLED panel, and a plurality of low voltage power source (OVSS) IN traces horizontally disposed at intervals on the OLED panel, wherein the sub-pixels in each row are electrically connected to one of the OVSS IN traces, and
the OVSS IN traces are used to input an OVSS voltage to each of the sub-pixels; and
wherein when a plane voltage of each of the OVSS IN traces is connected to a cathode of the OLED panel, an R′ resistor is equivalently connected between the OVSS IN trace and the corresponding sub-pixel; when the OLED panel emits light, the OVSS voltage inputted to the sub-pixel is increased compared to a voltage on the OVSS IN trace.

14. The OLED display panel of claim 13, wherein the OLED display panel uses a method for improving OVSS voltage drop of an OLED display panel, comprising following steps:
step S1, providing the OLED display panel, wherein the display panel comprises an OLED panel, a plurality of sub-pixels arranged in an array on the OLED panel, and a plurality of OVSS IN traces horizontally disposed at intervals on the OLED panel, the sub-pixels in each row are electrically connected to one of the OVSS IN traces, and
each of the OVSS IN traces is configured to input an OVSS voltage to each of the sub-pixels;
step S2, calculating an equivalent resistance R′ between the adjacent sub-pixels;
step S3, calculating a current I_{ds} flowing through each of the sub-pixels in each row according to a value of V_{data};
step S4, calculating a value of raising voltage V_{OVSS} of each of the sub-pixels in each row,
wherein a total current I of the sub-pixels in each row is calculated first, and then a voltage value between the adjacent sub-pixels in each row is calculated; and
step S5, adjusting the value of V_{data} according to the calculated value of raising voltage V_{OVSS} of each of the sub-pixels in each row, and using the adjusted V_{data} to drive the OLED display panel for screen display.

15. The OLED display panel of claim 13, wherein a circuit of each of the plurality of sub-pixels comprises a first thin film transistor (T1), a second thin film transistor (T2), a third thin film transistor (T3), a first capacitor (C1), and an organic light-emitting diode (D); and
a gate of the first thin film transistor (T1) is connected to a first control signal (WR), a source is connected to the data signal (V_{data}), and a drain is electrically connected to a first node (g); a gate of the second thin film transistor (T2) is electrically connected to the first node (g), a source is electrically connected to a power supply voltage (OVDD), and a drain is electrically connected to a second node (s); a gate of the third thin film transistor (T3) is electrically connected to a second control signal (RD), a source is electrically connected to the second node (s), and a drain is electrically connected to a first reference voltage (Verf); an end of the first capacitor (C1) is electrically connected to the first node (g), and the other end is electrically connected to the second node (s); and an anode of the organic light-emitting diode (D) is electrically connected to the second node (s), and a cathode is electrically connected to a corresponding OVSS trace.
